(19) United States
(12) Patent Application Publication
(10) Pub. No.: US 2004/0174981 A1
(43) Pub. Date: Sep. 9, 2004

(54) Interactive system, interaction control method, and interaction control program

(76) Inventor: Hirohide Ushida, Nagaokakyo-city (JP)

Correspondence Address: Jonathan P. Osha, Rosenthal & Osha L.L.P., Suite 2800, 1221 McKinney St., Houston, TX, 77010, US

(21) Appl. No.: 10/788,742

(22) Filed: Feb. 27, 2004

(30) Foreign Application Priority Data
Mar. 4, 2003 (JP) 056943/2003
Jan. 16, 2004 (JP) 009379/2004

(51) Int. Cl. H04M 3/00

(52) U.S. Cl. 379/280; 379/355.02

(57) ABSTRACT

According to the invention, it is possible that a plurality of terminals participate in interaction processing without imposing limitations such as presence or absence of pre-registration and a kind of a terminal. Further, even if the interaction processing is disconnected halfway through a task, it is possible to resume the interaction processing from a status in which disconnection has occurred. While ContextID for identifying the interaction processing and StateID for indicating a degree of progress of the interaction processing are stored in a ContextID database 6, ContextID and StateID are transmitted to the terminal. Then, in the case where the same ContextID is received from another terminal, another terminal is caused to participate in the ongoing interaction processing halfway through a task. Further, the interaction processing is caused to be resumed from the point, in which the interaction processing is interrupted, by referring to StateID.

### BACKGROUND OF THE INVENTION

1. Field of the Invention

The present invention relates to an interactive system which executes a series of interaction processings in response to information received from a terminal of a cellular phone, a personal computer, or the like.

2. Description of the Prior Art

A telephone automatic answering system and the like are known as such kind of interactive system. In the conventional telephone automatic answering system, between a user and the telephone automatic answering system, a call is established in such a manner that one becomes a calling party and the other becomes a called party. Interaction is performed between the calling party and the called party while the call is established. In order to achieve the purpose of the user, the interaction processing is configured by a series of information exchanges performed between the calling party and the called party. For example, in the interaction for the purpose of the reservation of a train ticket, the series of information exchange such as a departure station, arrival station, date, the number of tickets, type of seat, attribution information (name and user number) of the train to be reserved is performed.

In recent years, the system in which the interaction processing with a combination of voice interaction and data communication is performed by combining the telephone automatic answering system and a Web server has been proposed (for example, Japanese Unexamined Patent Publication Nos. 2001-268241 and 2002-183160).

However, in the system described in Japanese Unexamined Patent Publication No. 2001-268241, it is necessary to provide a corresponding table of an IP address and a telephone number of a wireless portable terminal on the system side. Therefore, there is generated a constraint that the system can be utilized only by a registered user, i.e. the terminal which has been registered in advance in the corresponding table. Further, in the system, since the terminal participating in the interaction processing is limited to a voice terminal and a data terminal, there are also the constraints such as a kind of the terminal, combination, the number of terminals. These constraints becomes a large drawback when diffusion of the interactive system and increase in users are intended.

Generally, since the IP address of the cellular phone is automatically allocated by a carrier of the cellular phone, it is not realistic that the corresponding table is provided on the center side.

In the system described in Japanese Unexamined Patent Publication No. 2002-183160, although the voice communication and the data communication are performed through the different networks in the communication between the cellular phone and the system, the system does not have means for performing the correspondence between the voice communication and the data communication. Therefore, in the configuration disclosed in Japanese Unexamined Patent Publication No. 2002-183160, when information is requested by the voice communication, a return address can not specified by the data communication, so that the system disclosed in Japanese Unexamined Patent Publication No. 2002-183160 can not be actually realized.

In the conventional system, there is also the following problem.

That is to say, in the conventional interactive system, when the call is disconnected halfway, the uncompleted interaction processing is usually discarded. Accordingly, in the case where the call is disconnected despite the intention of the caller, it is necessary that the interaction processing is started from the beginning such as making a call again. As a result, there is the problem that excessive charge for a call and time must be consumed by performing the interaction from the beginning again.

In mobile terminals represented by the cellular phone, the call is often disconnected on the halfway of the interaction by influence of reception of a radio wave, or the like, and communication cost is expensive compared with a fixed telephone and a fixed terminal, so that the above problem becomes particularly serious.

### SUMMARY OF THE INVENTION

In view of the foregoing, it is an object of the invention to provide a technology which the plurality of terminals can participate in the interaction processing without imposing limitations such as presence or absence of pre-registration and a kind of the user terminal.

Another object of the invention is to provide the technology which can resume the interaction processing from a status in which the disconnection has occurred, even if the interaction processing is disconnected halfway through a task.

The invention relates to the interactive system, the interaction control method, and interaction control program.

According to the device described above, following effects can be obtained.

In order to achieve the above object, in the invention, a computer system having a communication device performing communication with the terminal and a storage device controls the interaction as follows:

An interaction control device executes a series of interaction processings in response to information received from the terminal. When the interaction control device receives the information from the terminal, the interaction control device automatically generates or selects proper response information according to the information to transmit a reply to the terminal. The interaction processing between the terminal and the interactive system proceeds by repeating the information exchange.

When the interaction control device starts the new interaction processing with a terminal, the interaction control device transmits identification information for identifying the interaction processing to the terminal, while storing the identification information in the storage device. Since the identification information is given in each interaction processing, even if the plurality of interaction processings are being executed at the same time, one interaction processing can be specified on the basis of the identification information.

In the case where the interaction control device receives the same identification information as the identification information of the ongoing interaction processing from the terminal or another terminal different from the terminal when the interaction processing is in progress, the interaction control device permits the terminal to participate in the interaction processing concerned with the identification information.

According to the interaction control described above, the participation in the desired interaction processing can be performed halfway through a task only by transmitting the identification information from the terminal side to the interactive system. In the conventional system, the terminals directly correspond to each other in the corresponding table, and one interaction processing is executed to both the terminals. On the other hand, the system of the invention has a configuration in which the plurality of terminals are associated in one interaction processing by determining the interaction processing in which the terminal is caused to participate on the basis of ContextID transmitted from the terminal side. Accordingly, the plurality of terminals can participate in the interaction processing without imposing limitations such as presence or absence of pre-registration, the kind of the user terminal, and the number of terminals.

Further, it is preferable to perform the interaction control in the following way.

When the interaction control device starts the new interaction processing with a terminal, the interaction control device stores the identification information for identifying the interaction processing in the storage device. When the interaction processing is in progress, the interaction control device stores the identification information in the storage device while progress information for indicating a degree of progress is corresponded to the identification information. It is possible to manage the degree of progress of each interaction processing by giving the progress information in addition to the identification information.

After the interaction processing is interrupted, in the case where interaction control device receives the same identification information as the identification information of the interrupted interaction processing from the terminal or another terminal different from the terminal, the interaction control device permits the terminal to participate in the interaction processing from the degree of progress in which the interruption has occurred.

According to the above-described interaction control, even if the interaction processing is disconnected halfway through a task, since the interaction processing can be resumed from a state in which the disconnection has occurred only by transmitting the identification information from the terminal side to the interactive system side, the trouble that the interaction processing is started from the beginning again can be saved.

Whether the identification information received from the terminal is the same or not determines whether the terminal is caused to continuously participate in the interrupted interaction processing or not, so that it is not necessary that the terminal before the interruption is identical to the terminal after the interruption.

The terminals used by the user are mainly divided into a voice terminal and a data terminal, and the invention can be applied to any terminals irrespective of a kind of the terminal. In the case where the invention covers only the voice terminal, it is possible that a voice communication device which performs voice communication with the voice terminal through a line switching network is used as the communication device. In the case where the invention covers only the data terminal, it is possible that a data communication device which performs data communication with the data terminal through a data exchange network is used as the communication device.

When both the voice communication device and the data communication device are provided as the communication device, an interaction processing service can be offered to both the voice terminal and the data terminal. In this case, the plurality of terminals including the voice terminal and the data terminal can participate in one interaction processing, and the voice terminal and the data terminal can be changed according to the kind of the transmitted and received information, so that usability of the system and convenience are improved.

Various kinds of information can be adopted to the identification information given to the interaction processing. That is to say, at least one interaction processing can be identified from other interaction processings, and a specific format, generating method, and the like of the identification information can be properly selected according to a system configuration, operational circumstances, or the like.

For example, the identification information can be also issued to the interaction processing which the interaction control device newly starts so that the identification information of the new interaction processing does not overlap with the identification information of another already ongoing interaction processing.

It is also preferable that the interaction control device uses intrinsic information as the identification information in the terminal which starts the new interaction processing. A telephone number and an IP address of the terminal can be thought as an example of the intrinsic information. When the interactive system has the configuration in which the intrinsic information is used as the identification information in the terminal, the interactive system can automatically obtain the identification information. Therefore, it is not necessary that the user by oneself inputs the identification information, a decrease in input load and improvement of user-friendliness can be realized. For example, after the interaction processing is interrupted, when access to the interactive system is performed by the same terminal, the terminal can be automatically caused to participate in the interaction processing before the interruption.

It is also preferable that the interaction control device uses positional information of the terminal which starts the new interaction processing as the identification information. The information on a base station or a router which is connected to the terminal, or latitude information and longitude information in which the terminal is located can be thought as an example of the positional information. When the interactive system has the configuration in which the positional information is used as the identification information, the interactive system can also automatically obtain the identification information. Therefore, the same advantages as the case in which the intrinsic information is used as identification information in the terminal can be obtained.

It is preferable that the interaction control device sets a predetermined valid duration to the identification information and deletes the identification information from the storage device in the case where interruption time of the interaction processing exceeds the valid duration. Thus, the interaction processing having low possibility of resumption can be disposed of.

In the interaction processings which are being concurrently executed, the pieces of the identification information must not overlap with each other. Therefore, it is preferable that a data size of the identification information is sufficiently secured according to the scale of the system or the like so that the identification information given to the interaction processing is not run out. That is to say, in the case where the identification information is the combination of figures or letters, it is preferable that the sufficiently large number of digits (the number of letters) of the identification information is taken. However, when the digit number of the identification information is increased, it is difficult for the user to memorize the identification information, and input operation into the terminal becomes inconvenient for the user. Therefore, as described above, when the identification information which has elapsed the valid duration is sequentially deleted, even if the data size of the identification information is decreased, there is the advantage which can avoid the problems that the pieces of the identification information overlap with each other and the identification information is run out.

It is possible that the interaction control device can cause the terminal newly connected to the interactive system to select whether the terminal starts the new interaction processing or the terminal participates in the already ongoing interaction processing. This enables the convenience of the system to be improved.

In the case where the intrinsic information is used as the interaction processing in the terminal, the interaction control device obtains the intrinsic information from the terminal which is newly connected to the system. In the case where the intrinsic information coincides with the identification information stored in the storage device, the terminal can be automatically caused to participate in the interaction processing concerned with the identification information. As a result, for example, in the case where the processing is resumed from the same terminal after the interruption of the interaction processing, the user can immediately resume the interaction processing before the interruption without any special input operation, so that the convenience of the system is improved.

The invention can be interpreted as the interactive system which includes at least a part of the devices realizing the above procedures. The invention can be interpreted as the interaction control method including at least a part of the above procedures or the interaction control program for realizing the interaction control method. The invention can be configured by the combination of each of the devices and procedures as much as possible.

For example, it is preferable that the interaction system according to a mode of the invention includes a communication device which performs communication with a terminal, an interaction control device which executes a series of interaction processings in response to information received from the terminal, and a storage device, when the new interaction processing is started, the interaction control device transmits the identification information for identifying the interaction processing to the terminals while storing the identification information in the storage device, and the interaction control device can cause the terminal to participate in the interaction processing concerned with the identification information, in the case where the interaction control device receives the same identification information as the identification information of the ongoing interaction processing from the terminal or another terminal different from the terminal when the interaction processing is in progress.

It is also preferable that the interaction system according to a mode of the invention includes a communication device which performs communication with a terminal, an interaction control device which executes a series of interaction processings in response to information received from the terminal, and a storage device, when the new interaction processing is started, the interaction control device transmits the identification information for identifying the interaction processing to each terminals while storing the identification information in the storage device, when the interaction processing is in progress, the interaction control device stores progress information for indicating a degree of progress of the interaction processing in the storage devices while the progress information is corresponded to the identification information, and, when the interaction control device receives the same identification information as the identification information of the interrupted interaction processing from the terminal or another terminal different from the terminal after the interaction processing is interrupted, the interaction control device can cause the terminal to participate in the interaction processing from the degree of progress in which the interruption has occurred.

In the interaction control method according to a mode of the invention, it is preferable that a computer system having a communication device performing communication with a terminal and a storage device transmits identification information for identifying interaction processing to the terminal while storing the identification information in the storage device when the new interaction processing is started, the computer system executes a series of interaction processings in response to information received from the terminal, and the computer system can cause the terminal or another terminal different from the terminal to participate in the interaction processing concerned with the identification information, in the case where the computer system receives the same identification information as the identification information of the ongoing interaction processing from the terminal or another terminal different from the terminal when the interaction processing is in progress.

In the interaction control method according to a mode of the invention, it is also preferable that a computer system having a communication device performing communication with a terminal and a storage device transmits identification information for identifying interaction processing to the terminal while storing the identification information in the storage device when the new interaction processing is started, the computer system executes a series of interaction processings in response to information received from the terminal, the computer system stores the identification information in the storage device while progress information for indicating a degree of progress is corresponded to the identification information when the interaction processing is in progress, and the computer system permits the terminal or another terminal different from the terminal to participate in the interaction processing from the degree of progress in which interruption has occurred when the same identification information as the identification information of the interrupted interaction processing is received from the terminal or another terminal different from the terminal after the interaction processing is interrupted.

In the interaction control program according to a mode of the invention, it is preferable that a computer system including a communication device performing communication with a terminal and a storage device is caused to execute steps of transmitting identification information for identifying interaction processing to the terminal while storing the identification information in the storage device when the new interaction processing with the terminal is started, executing a series of interaction processings in response to information received from the terminal, permitting the terminal or another terminal different from the terminal to participate in the interaction processing concerned with the identification information, in the case where the same identification information as the identification information of the ongoing interaction processing is received from the terminal or another terminal different from the terminal when the interaction processing is in progress.

In the interaction control program according to another mode of the invention, it is also preferable that a computer system including a communication device performing communication with a terminal and a storage device is caused to execute steps of transmitting identification information for identifying interaction processing to the terminal while storing the identification information in the storage device when the new interaction processing with the terminal is started, executing a series of interaction processings in response to information received from the terminal, storing the identification information in the storage device while progress information for indicating a degree of progress is corresponded to the identification information, when the interaction processing is in progress, and permitting the terminal or another terminal different from the terminal to participate in the interaction processing from the degree of progress in which interruption has occurred, when the same identification information as the identification information of the interrupted interaction processing is received from the terminal or another terminal different from the terminal after the interaction processing is interrupted.

According to the invention, it is possible that the plurality of terminals participate in the interaction processing without imposing limitations such as presence or absence of pre-registration and the kind of the user terminal.

Further, even if the interaction processing is disconnected halfway through a task, it is possible to resume the interaction processing from the status in which the disconnection has occurred.

### BRIEF DESCRIPTION OF THE DRAWINGS

FIG. 1 shows a schematic view of an overview of an interactive system according to an embodiment of the invention.

FIG. 2 shows a block diagram of a functional configuration of the interactive system.

FIG. 3 shows a flow chart of interaction control processing performed by an interaction control unit.

FIG. 4 shows a flow chart of disposition processing of ContextID performed by the interaction control unit.

FIG. 5 schematically shows a flow chart of interaction processing between the interactive system according to an embodiment of the invention and a cellular phone and a personal computer.

### DESCRIPTION OF THE PREFERRED EMBODIMENTS

Preferred embodiments of the invention will be described below referring to the accompanying drawings.

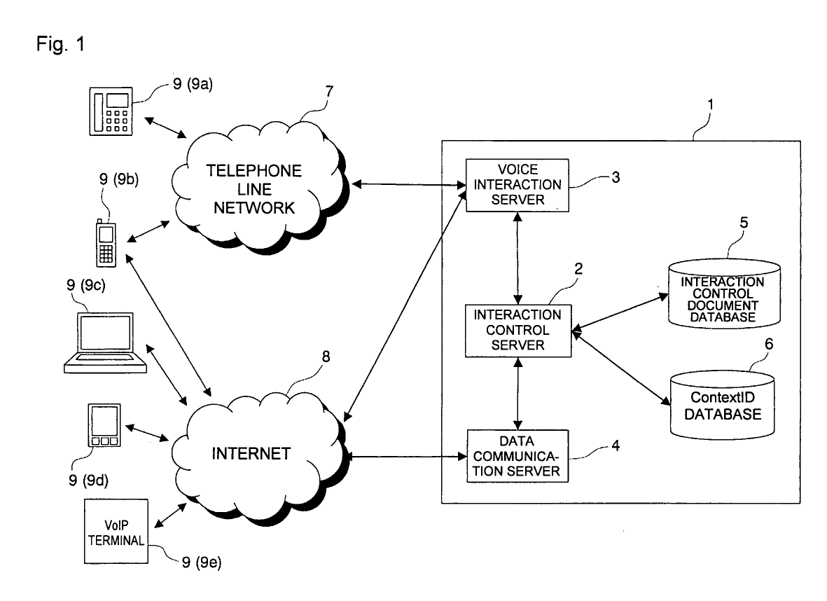

FIG. 1 is a schematic view showing an overview of an interactive system 1 according to an embodiment of the invention. The interactive system 1 is a computer system which mainly includes an interaction control server 2, a voice interaction server 3, a data communication server 4, an interaction control document database 5, and a ContextID database 6. The interactive system 1 can be constituted not only by one computer, but also by a combination of the plurality of computers. In the embodiment, each component is realized by individual computer in order to disperse a processing load.

A general-purpose personal computer, a work station, or a server device, which includes CPU (central processing unit), a memory, a hard disk drive, a communication adaptor, and the like as basic hardware, can be used as the computer constituting the interactive system 1. A program for realizing the interactive system 1 is stored in the hard disk drive of the computer. When the program is read and executed in CPU during operation, the following functions of the interactive system 1 is exerted by cooperation of software and each piece of hardware.

The voice interaction server 3 is the device which functions as the communication device performing voice communication between the interactive system 1 and a user terminal 9 through a telephone line network 7 which is of a line switching network. The voice interaction server 3 also has the function of performing the voice communication by VoIP (voice over Internet protocol) through the Internet 8 which is of a data exchange network.

The data communication server 4 is the device which functions as the communication device performing data communication between the interactive system 1 and the user terminal 9 through the Internet 8.

The interaction control server 2 is the device which functions as the interaction control device executing a series of interaction processings in response to information from the user terminal 9 through the telephone line network 7 or the Internet 8. The interaction control server 2 is connected to the voice interaction server 3 and the data communication server 4. The interaction control server 2 executes the interaction processing in conjunction with the interaction control document database 5 and the ContextID database 6.

The interaction control document database 5 is a storage device for storing and managing an interaction control document, and the interaction control document database 5 has the function of transferring the corresponding interaction control document in response to request from the interaction control server 2. The documents described in markup languages such as VoiceXML (Voice extensible markup language), SALT (speech application language tags), and XHTML (extensible hypertext markup language) can be used as the interaction control document.

The ContextID database 6 is the storage device for storing and managing ContextID and StateID while ContextID is corresponded to StateID. ContextID is identification information for identifying the interaction processing, and ContextID is allocated in each interaction processing. StateID is progress information which indicates a degree of progress of the interaction processing. The interactive system 1 manages the interaction processing in execution, the degree of the progress of the interaction processing, and the user terminal 9 taking part in the interaction processing by using ContextID and StateID.

Various terminals which can be connected to the telephone line network 7 or the Internet 8 can be used as the user terminal 9. In FIG. 1, a fixed telephone 9a and a cellular phone 9b are shown as an example of voice terminals which can be connected to the telephone line network 7, the cellular phone 9b, PC (personal computer) 9c, and PDA (personal digital assistance) 9d are shown as an example of data terminals which can be connected to the Internet 8, and a VoIP terminal 9e is shown as an example of voice terminals which can be connected to the Internet 8.

The interactive system 1 of the embodiment includes the voice interaction server 3 and the data communication server 4, and the interactive system 1 can provide interaction processing service to both the voice terminal and the data terminal. The user can participate in one interaction processing from the various kinds of the plurality of terminals or switch the terminals according to the kind of information which is transmitted and received between the interactive system 1 and the user. Although the cellular phone 9b having the function of connecting to the Internet is physically one terminal, the cellular phone 9b is logically recognized as two terminals of the voice terminal and the data terminal by the interactive system 1.

Although FIG. 1 illustrates the Internet 8 as the data exchange network, a wide area network except the Internet, LAN (local area network), a cellular phone packet switching network, and the like also correspond to the data exchange network.

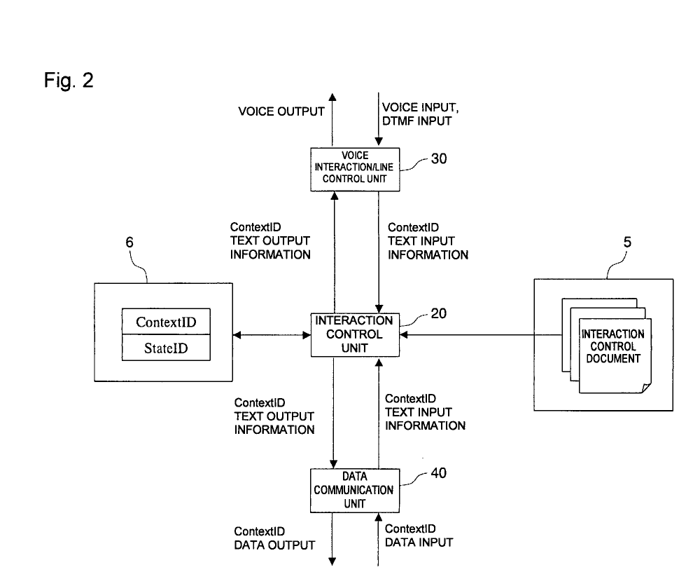

Referring to FIG. 2, a functional configuration of the interactive system 1 will be described in detail.

FIG. 2 shows a block diagram of the functional configuration of the interactive system 1. In FIG. 2, an interaction control unit 20 is realized by the interaction control server 2, a voice interaction/line control unit 30 is realized by the voice interaction server 3, and a data communication unit 40 is realized by the data communication server 4.

The voice interaction/line control unit 30 is the device which mainly performs line control and voice interaction control, and the voice interaction/line control unit 30 performs transmission and reception of voice information between the interactive system 1 and the voice terminal through the telephone line or the data communication line.

The voice interaction/line control unit 30 has a line control unit and an IP (Internet protocol) communication control unit as the function concerned with the line control. The line control unit is a part which performs the line switching of the plurality of telephone lines connected to the voice interaction server 3. The IP communication control unit is a part which performs the transmission and reception of the voice information by VoIP through the data communication line. The interaction control unit 20 manages a session provided to the terminal while the session is corresponded to ContextID. Specifically, while ContextID is generated at a step in which the initial communication is performed from the terminal to store ContextID in the ContextID database 6, ContextID is acknowledged to the terminal. In the case where the terminal is the fixed telephone or the cellular phone and a telephone number of the fixed telephone or the cellular phone is used as ContextID, since almost all of the cases are the case in which the user knows the telephone number of the terminal which is owned by the user, the acknowledgement of ContextID to the terminal can be omitted. It is also possible that ContextID in the form of the voice information is acknowledged to the fixed telephone or the cellular phone through the voice interaction/line control unit 30 without omission.

The session means a unit of the connection between the interactive system 1 and the terminal. Since the telephone line is the line switching network, one session covers a period from establishment of the connection till the disconnection of the telephone line. Since the data communication line is the packet switching network, one connection covers the period from the establishment of the connection till the disconnection of the telephone line (single communication unit in TCP (transmission control protocol)), and the unit of the connection which can identify one terminal over the plurality of connections becomes one session. In the embodiment, the interaction processing can be maintained irrespective of the kind of the terminal or the session by recognizing the interaction processing by the ContextID transmitted from the terminal.

The voice interaction/line control unit 30 has an IVR (interactive voice response) unit as the function concerned with the voice interaction. The IVR unit executes automatic response processing with the voice between the interactive system 1 and the user terminal, and the IVR unit includes a voice recognition unit, a DTMF (dual tone multi frequency) recognition unit, a voice synthesis unit, a sound recording file reproducing unit, and a voice interaction control document interpretation/execution unit.

When the voice interaction/line control unit 30 receives voice information from the user terminal, the voice interaction/line control unit 30 performs voice recognition processing to convert the voice information into text input information with the voice recognition unit. When the voice interaction/line control unit 30 receives DTMF (so-called push sound), the voice interaction/line control unit 30 converts DTMF into the text input information with the DTMF recognition unit. Then, the voice interaction/line control unit 30 transmits the text input information and ContextID to the interaction control unit 20.

On the other hand, when the voice interaction/line control unit 30 receives text output information and ContextID from the interaction control unit 20, the voice interaction/line control unit 30 executes the following processing. The text output information contains URI (uniform resource identifiers) of a voice interaction control document, text data, and the sound recording file and the like. Therefore, the voice interaction/line control unit 30 generates voice information for response by synthesizing the voice from the text data with the voice synthesis unit, obtaining and reproducing the sound recording file with the sound recording file reproducing unit, or executing the voice interaction control document with the voice interaction control document interpretation/execution unit. Then, the voice interaction/line control unit 30 specifies the terminal to which the voice information should be transmitted on the basis of ContextID and transmits the voice information to the terminal.

It is possible that the data stored in the hard disk drive of the voice interaction server 3 is used as the data (for example, grammar and dictionary) used in the voice recognition and the data (foe example, sound recording file and phoneme data) used in the voice synthesis, and it is also possible that the data obtained from other devices connected through the network is used as the data used in the voice recognition and the data used in the voice synthesis.

The data communication unit 40 is the device which performs the transmission and reception of the data between the interactive system 1 and the data terminal through the data communication network. The data communication unit 40 is constructed as a WWW (world wide web) server, and the data terminal can communicate with the data communication unit 40 by utilizing a WWW client.

The data communication unit 40 adds ContextID when data communication is performed between the interactive system 1 and the data terminal. That is to say, the transmission and reception of a set of the data and ContextID are performed by the data communication unit 40. When the data is received from the data terminal, the data communication unit 40 can specify the interaction processing in which the data terminal participates. As described above, the data communication unit 40 also has the function of acknowledging ContextID to the data terminal. The data communication unit 40 can specify the terminal of a called party on the basis of ContextID in such a manner that the data communication unit 40 also manages the session provided to the terminal while the session is corresponded to ContextID received from the user terminal.

The data transmitted and received between the data terminal and the data communication unit 40 includes both the text data and binary data. An HTML (hypertext markup language) file, an XHTML file, plain text data can be cited as an example of the text data. A document file, an image file, a voice file, a moving picture file can be cited as the binary data.

When the data communication unit 40 receives the data from the user terminal, the data communication unit 40 converts the data into data input information to transmit the data and ContextID to the interaction control unit 20. When the data communication unit 40 receives data output information and ContextID from the interaction control unit 20, the data communication unit 40 specifies the terminal to which the data should be transmitted on the basis of ContextID, while generating the data transmitted to the terminal on the basis of the data output information. Then, the data communication unit 40 transmits the data and ContextID to the terminal.

The interaction control unit 20 controls and manages start, resumption, progress, end, and the like of the interaction processing in conjunction with each of the voice interaction/line control unit 30, the data communication unit 40, the ContextID database 6, and the interaction control document database 5.

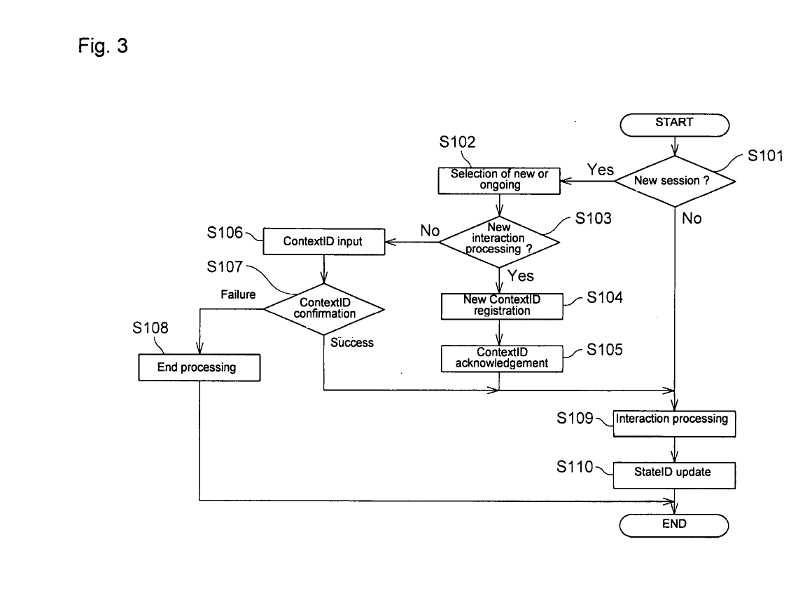

FIG. 3 shows a flow chart of interaction control processing performed by the interaction control unit 20. When the interaction control unit 20 receives the text input information from the voice interaction/line control unit 30 or receives the data input information from the data communication unit 40, at first the interaction control unit 20 decides whether the connection to the terminal is the new session or not (Step S101).

In the case of the new session, the interaction control unit 20 causes the newly connected terminal to select whether the terminal starts the new interaction processing or the terminal participates in the ongoing interaction processing (Step S102).

Specifically, in the case where the terminal is the voice terminal, the interaction control unit 20 transmits the corresponding voice interaction control document as the text output information to the voice interaction/line control unit 30. Then, the interaction control unit 20 can transmit a response message to the voice terminal such as “in the case of start of new interaction processing, please press “1”, in the case of participation in ongoing interaction processing, please press “2”” to encourage the input from the user. In the case where the terminal is the data terminal, the interaction control unit 20 transmits the corresponding interaction control document as the data output information to the data communication unit 40. Then, the interaction control unit 20 can transmit a selection screen to the data terminal such as “start of new interaction processing? “YES” or “NO”” to encourage the input from the user.

The input from the user is received by the voice interaction/line control unit 30 or the data communication unit 40, and the input from the user is transmitted as the text input information or the data input information to the interaction control unit 20. The interaction control unit 20 decides whether the terminal starts the new interaction processing or the terminal participates in the ongoing interaction processing on the basis of the text input information or the data input information (Step S103).

When the new interaction processing is started between the interactive system and the user terminal, the interaction control unit 20 gives ContextID to the interaction processing and stores ContextID in the ContextID database 6 (Step S104). Subsequently, the management of the interaction processing is performed by using ContextID.

At this point, the given ContextID can only identify the new interaction processing from other already ongoing interaction processings, and any piece of information can be used. For example, the interaction control unit 20 can issue new ID to the newly started interaction processing so that ContextID of the newly started interaction processing does not overlap with ContextID of the already ongoing interaction processing. In the embodiment, the above method is adopted.

ContextID given in the above-described way is acknowledged to the user of the terminal through the voice interaction/line control unit 30 or the data communication unit 40 (Step S105). For example, in the case of the voice terminal, ContextID can be acknowledged by reading ContextID by the voice synthesis or the like, in the case of the data terminal, ContextID can be acknowledged by transferring ContextID in the form of the data or displaying ContextID on a display screen. The acknowledged ContextID is utilized in the case of the resumption of the interrupted interaction processing or in the case of the participation in the interaction processing from other terminal.

After the new ContextID is acknowledged, the interaction processing between the interactive system 1 and the terminal is started (Step S109).

In the case where the terminal is caused participate in the ongoing interaction processing, an input request of ContextID is transmitted to the terminal (Step S106). This processing is also executed according to the interaction control document. That is to say, in the case of the voice terminal, the input from the user can be encouraged by the response message such as “Please say ContextID of interaction processing in which you want to participate”. In the case of the data terminal, the input from the user can be encouraged by transmitting the input screen such as “Please input ContextID of interaction processing in which you want to participate” to the data terminal.

When the interaction control unit 20 receives ContextID from the terminal, the interaction control unit 20 verifies whether the same ID as the received ContextID is registered in the ContextID database 6 or not (Step S107).

In the case where the interaction control unit 20 fails the verification (when the same ContextID is absent), the interaction control unit 20 acknowledges to the terminal that the corresponding interaction processing is absent (Step S108).

In the case where the interaction control unit 20 succeeds in the verification (when the same ContextID is present), the interaction control unit 20 causes the terminal to participate in the interaction processing concerned with ContextID (Step S109). In the case where other terminal which has already participated in the interaction processing is present, the new terminal additionally participates in the interaction processing. The number of terminals or the kind of the terminal (voice terminal or data terminal) which is able to participate in one interaction processing can be properly set according to a scale of the interactive system, contents of the interaction processing, or the like. In the case where other terminal which currently participates in the interaction processing is absent (such as the state in which the communication is disconnected halfway through a task) the interaction processing is resumed by the new terminal.

In Step S109, the interaction control unit 20 obtains StateID corresponding to ContextID from the ContextID database 6. StateID is the information indicating the progress of the interaction processing. For example, the information including a combination of URI and a line number of the interaction control document is used for StateID. The interaction control unit 20 reads the interaction control document to be executed on the basis of StateID, and the interaction control unit 20 interprets and executes the interaction control document from the corresponding line. That is to say, in the case of the additional participation in the interaction processing or the resumption of the interaction processing, the processing is executed from halfway of a series of interaction processings.

In the case where the terminal of the called party is the voice terminal, the interaction control unit 20 automatically generates or selects proper response information on the basis of the interaction control document. The response information contains URI (Uniform Resource Identifiers) of the voice interaction control document, the text data, and the sound recording file and the like. The response information and ContextID are transmitted as the data output information to the voice interaction/line control unit 30.

In the case where the terminal of the called party is the data terminal, the interaction control unit 20 automatically generates or selects the proper response information on the basis of the interaction control document. The response information contains the text data and the binary data. The response information and ContextID are transmitted as the text output information to the data communication unit 40.

Sometimes the interaction control unit 20 responds to only the voice terminal, only the data terminal, or both the voice terminal and the data terminal depending on the contents of the interaction processing to be executed. For example, the processing in which the image or the moving picture is displayed is executed only to the data terminal, and the processing in which the voice is reproduced is executed only to the voice terminal.

When the interaction processing of the corresponding StateID is normally executed, the interaction control unit 20 updates StateID of the ContextID database 6 and ends the processing (Step S110).

The interaction processing between the terminal and the interactive system 1 proceeds by repeating the processing shown in FIG. 3. That is to say, during when the session between the terminal and the interactive system 1 is held, the processings of Step S101, Step S109, and Step S110 are repeated in each time when the information is received from the terminal, and StateID is updated while the interaction processing proceeds. In the case where the interaction processing is completed, ContextID and StateID are deleted from the ContextID database 6.

According to the interaction control processing described above, when the new interaction processing is started, ContextID is given in each interaction processing, so that one interaction processing can be specified on the basis of ContextID, even if the plurality of interaction processings are simultaneously executed.

In the case where the same ContextID is received from other terminal while the interaction processing is in progress, other terminal is caused to additionally participate in the ongoing interaction processing, so that other terminal can participate in the desired interaction processing halfway through a task only by transmitting ContextID from the terminal side to the interactive system 1 side. In the conventional system, the terminals are directly corresponded to each other in the corresponding table, and one interaction processing is executed to both the terminals. On the other hand, the system of the embodiment has the configuration in which the plurality of terminals are associated within one interaction processing by determining the interaction processing in which the terminal is caused to participate on the basis of ContextID transmitted from the terminal side. Accordingly, the plurality of terminals can participate in the interaction processing without imposing limitations such as presence or absence of pre-registration, the kind of the user terminal, and the number of terminals.

In the ContextID database 6, since the progress of the interaction processing is managed by each ContextID and StateID, even if the interaction processing is disconnected halfway through a task, the interaction processing can be resumed from a status in which the disconnection has occurred only by transmitting ContextID from the terminal side to the interactive system side, and the trouble that the interaction processing is started from the beginning again can be saved. For example, even if the wireless terminal moves to a place where a radio wave can not reach during the communication and the communication is disconnected, the interaction processing can be resumed from the status in which the disconnection has occurred in such a manner that the wireless terminal moves again to the place where the radio wave can reach.

Whether ContextID is the same or not determines whether the terminal is caused to continuously participate in the interrupted interaction processing or not, so that it is not necessary that the terminal before the interruption is identical to the terminal after the interruption. Therefore, a degree of freedom of the usage mode of the interactive system 1 is increased such that the interaction processing performed by the portable terminal is interrupted and the interaction processing is resumed by the fixed terminal after the user returns home, and the usability of the system and convenience are improved.

The voice interaction/line control unit 30 and the data communication unit 40 are provided, and the interaction control unit 20 controls the voice interaction/line control unit 30 and the data communication unit 40. As a result, the plurality of terminals of various kinds including the voice terminal and the data terminal can participate in one interaction processing, and the voice terminal and the data terminal can be changed according to the kind of the transmitted and received information, so that the usability of the system and the convenience are improved.

In Step S103, the terminal which is newly connected can select whether the terminal starts the new interaction processing or the terminal participates in the already ongoing interaction processing, so that the user can freely select whether the terminal starts the interaction processing from the beginning again or the interaction processing is started from the point before the interruption again, and the convenience of the system is improved.

In the interaction processings which are being concurrently executed, ContextIDs must not overlap with each other. Therefore, it is preferable that a data size of ContextID is sufficiently secured according to the scale of the system or the like so that ContextID given to the interaction processing is not run out. That is to say, in the case where ContextID is the combination of figures or letters, it is preferable that the sufficiently large number of digits (the number of letters) of ContextID is taken. However, when the digit number of ContextID is increased, it is difficult for the user to memorize ContextID, and input operation into the terminal becomes inconvenient for the user. Therefore, in the system of the embodiment, a valid duration is set to ContextID, and disposition processing in which ContextID is deleted is performed when interruption time of the interaction processing exceeds the valid duration.

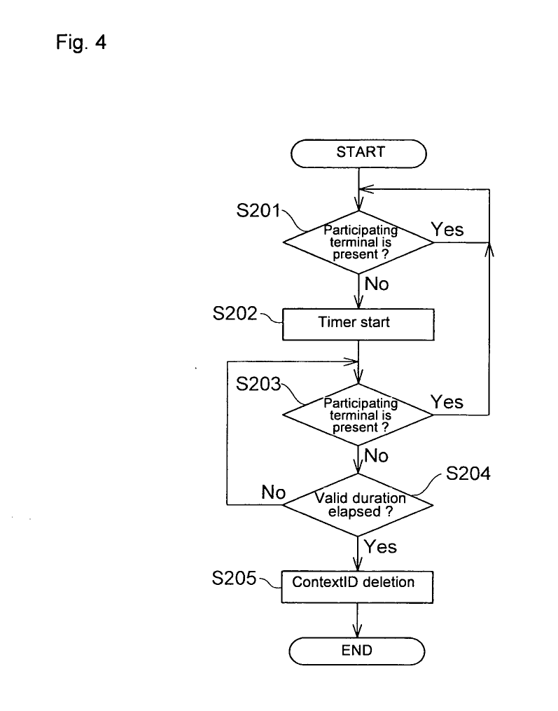

FIG. 4 shows the flow chart of the disposition processing of ContextID performed by the interaction control unit 20. The disposition processing is the process which executed independently of the interaction control processing shown in FIG. 3, and the disposition processing is independently executed to each of the interaction processing which is being executed.

The interaction control unit 20 confirms the presence or absence of the terminal which is taking part in the ongoing interaction processing at regular time interval (Step S201). In the case where the terminal taking part in the interaction processing is absent, a timer is started (Step S202), and the processings of Step S203 and Step S204 are repeated until predetermined time elapses. In Step S203, the presence or absence of the terminal which is taking part in the interaction processing is confirmed, and the timer is reset and the disposition processing returns to the initial step, when the terminal which participates in the interaction processing appears. In Step S204, it is checked whether a value of the timer becomes a predetermined value or not. The predetermined value is the valid duration of ContextID. It is possible to define the predetermined value by the scale of the system or the operation of the system.

In the case where the valid duration has elapsed while the terminal which participates in the interaction processing has not appeared, the interaction control unit 20 deletes the corresponding ContextID and StateID of the ContextID database 6 (Step S205). As a result, the interaction processing concerned with ContextID is also eliminated.

Thus, when ContextID (interaction processing) after the valid duration has elapsed is sequentially deleted, even if the data size of ContextID is decreased, the problem that ContextIDs overlap with each other or ContextID is run out can be avoided.

The above configuration is only one in which one of embodiments of the invention is illustrated. The scope of the invention is not limited to the above embodiment, and various modifications can be made within the range of the technical thought of the invention.

For example, the above embodiment has the configuration in which the interaction control unit 20 issues ContextID. However, in the case where the terminal has intrinsic information such as the telephone number and the IP address, it is preferable that the telephone number or the IP address is directly used as ContextID. The positional information can be directly used, in the case where the positional information, such as the information on a base station or a router which is connected to the terminal or latitude information and longitude information in which the terminal is located, can be obtained.

When the invention has the configuration in which the intrinsic information or the positional information is used as ContextID, the interactive system 1 can automatically obtain ContextID from the terminal.

In this case, the processing of Step S106 is not required. Accordingly, it is not necessary that the user by oneself inputs ContextID, the decrease in the input load and improvement of user-friendliness can be realized.

Further, in this case, it is preferable to eliminate the processing of Step S102. The intrinsic information or the positional information is obtained from the terminal which is newly connected to the interactive system 1. When the intrinsic information or the positional information corresponds to ContextID stored in the ContextID database 6, the terminal is caused to automatically participate in the interaction processing concerned with ContextID. Accordingly, in the case where the processing is resumed from the same terminal after the interruption of the interaction processing, since the user can immediately resume the interaction processing from the status in which the interruption has occurred without any special input operation, the convenience of the system is improved.

In the case where the interactive system 1 permits only the resumption processing performed by the same terminal and the intrinsic information or the positional information of the terminal is used as ContextID (in the case where ContextID can be automatically obtained from the terminal), it is not always necessary to acknowledge ContextID to the user of the terminal, so that the processing of Step S105 can be also omitted.

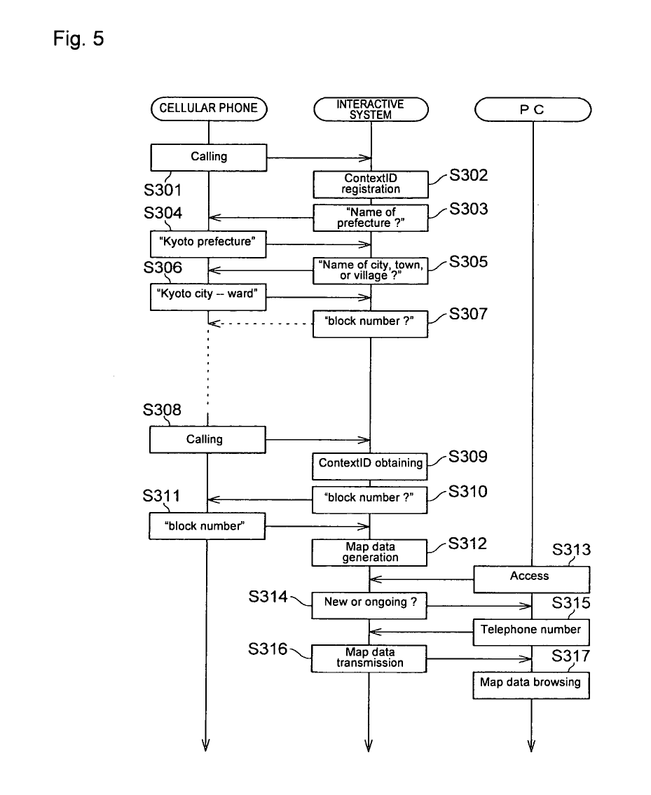

A specific example in which the interactive system according to the embodiment is applied to a map information offering service will be described referring to FIG. 5.

FIG. 5 schematically shows the flow chart of the interaction processing between the interactive system and the cellular phone which is of the voice terminal and PC (personal computer) which is of the data terminal.

The system is one for offering the service in which, when the address is inputted, map data of the location can be browsed.

The cellular phone calls the interactive system (Step S301). When the interactive system learns that the session provided to the new terminal is established, the interactive system obtains the telephone number or the IP address of the cellular phone (hereinafter referred to as telephone number and the like) and directly registers the telephone number and the like as ContextID in the database (Step S302). In the system, the intrinsic information of the terminal is used as the identification information of the interaction processing. At this point, however, omission is performed in FIG. 5, it is also possible that the determined ContextID is acknowledged to the cellular phone by the voice information or the data for the purpose of confirmation. As a result, the interactive system can recognize the single session in such a manner that ContextID is memorized in a memory unit in the cellular phone and ContextID is transmitted to the interactive system in each interaction processing.

When the interaction processing is started, voice guidance of “please say name of prefecture” is reproduced (Step S303). When the user answers “Kyoto prefecture” (Step S304), the system performs voice recognition processing to the received voice information and learns that the name of the prefecture is “Kyoto prefecture”.

Then, after a confirmation message of “the name of the prefecture is Kyoto” is reproduced, the voice guidance of “please say the name of city, town, or village” is reproduced (Step S305). In the example in FIG. 5, the user answers “Kyoto city,—ward” (Step S306). Correspondingly, “please say a block number,” the system responds (Step S307), and then, the interaction processing is interrupted by the disconnection of the caller.

When the user calls the interactive system again with the same cellular phone (Step S308), similarly the interactive system learns that the session provided to the new terminal is established, and the cellular phone transmits the telephone number and the like as ContextID to the interactive system (Step S309). At this point, in the interactive system, the same ContextID and StateID are registered in the ContextID database 6, so that the cellular phone can be caused to participate in the interrupted interaction processing halfway through a task. That is to say, the processing is resumed from the processing of inputting the block number by obtaining StateID on the basis of ContextID (Step S310).

When the interactive system receives the information of the block number from the user (Step S311), the interactive system generates the map data of the corresponding address (Step S312) and reproduces the voice guidance of “map data is ready.”

The embodiment shows an example in which the map information is browsed by other data terminal (PC).

When the user accesses the interactive system from PC (Step S313), the interactive system learns that the session provided to the new terminal is established. At this point, since PC is the data terminal which does not have the telephone number, the interactive system causes PC to select whether PC starts the new interaction processing or PC participates in the ongoing interaction processing (Step S314). In the case where PC participates in the ongoing interaction processing, it is assumed that the system has specifications in which ContextID is inputted on the selection screen.

When the user inputs ContextID on the selection screen displayed in PC, i.e. when the user inputs the telephone number and the like of the cellular phone in which the above interaction processing has been performed (Step S315), the interaction system can cause PC to additionally participate in the interaction processing. Then, the map information is transmitted to PC (Step S316). As a result, the user can browse the map information on PC having the larger screen (Step S317).

As described above, according to the system, the resumption processing after the interruption of the interaction processing can be easily performed, and participation to the same interaction processing can be easily performed from the plurality of terminals of the various kinds such as the cellular phone and PC.

The interactive system, the interaction control method, and the interaction control program of the invention are not limited to the above embodiments, and it is understood that various modifications could be made without departing from the spirit and scope of the invention.

The interactive system, the interaction control method, and the interaction control program of the invention can be utilized to telephone automatic response system, ticket reservation system, and the like.

What is claimed is:

1. An interactive system comprising:
a communication device which performs communication with at least one terminal;
a storage device which stores identification information for identifying interaction processing with the terminal; and
an interaction control device which reads out the identification information to transmits the identification information to the terminal which performs the interaction processing while setting the identification information to store the identification information in the storage device, the interaction control device controlling the interaction processing between the terminals by the same identification information transmitted from any one of the terminals.

2. An interactive system comprising:
a communication device which performs communication with at least one terminal;
a storage device which stores identification information for identifying interaction processing with the terminal; and
an interaction control device which performs control so that, when the new interaction processing with the terminal is started, the interaction control device transmits the identification information for identifying the interaction processing to each terminals while storing the identification information in the storage device, when the interaction processing is in progress, the interaction control device stores progress information for indicating a degree of progress of the interaction processing in the storage devices while the progress information is corresponded to the identification information, and, when the interaction control device receives the same identification information as the identification information of the interrupted interaction processing from the terminal or another terminal different from the terminal after the interaction processing with the terminal is interrupted, the interaction control device causes the terminal to participate in the interaction processing from the degree of progress in which the interruption has occurred.

3. The interactive system according to claim 2, in which the interaction control device can cause the terminal to participate in the interaction processing concerned with the identification information, in the case where the interaction control device receives the same identification information as the identification information of the ongoing interaction processing from the terminal or another terminal different from the terminal when the interaction processing is in progress.

4. The interactive system according to any one of claims 1 to 3, in which the communication device is a voice communication device which performs voice communication with the terminal or another terminal different from the terminal through a line switching network.

5. The interactive system according to any one of claims 1 to 3, in which the communication device is a data communication device which performs data communication with the terminal or another terminal different from the terminal through a data exchange network.

6. The interactive system according to any one of claims 1 to 3, in which the communication device has the voice communication device which performs the voice communication with the terminal through the line switching network and the data communication device which performs the data communication with the terminal or another terminal different from the terminal through the data exchange network.

7. The interactive system according to any one of claims 1 to 6, in which the interaction control device issues the identification information to the newly started interaction processing so that the identification information of the newly started interaction processing does not overlap with the identification information of another already ongoing interaction processing.

8. The interactive system according to any one of claims 1 to 6, in which the interaction control device uses intrinsic information as the identification information for the terminal which newly starts the interaction processing.

9. The interactive system according to claim 8, wherein the intrinsic information is a telephone number of the terminal or an address which is given to the terminal.

10. The interactive system according to any one of claims 1 to 6, in which the interaction control device uses positional information of the terminal which newly starts the interaction processing as the identification information.

11. The interactive system according to any one of claims 1 to 10, in which the interaction control device sets a predetermined valid duration to the identification information, and
the interaction control device deletes the identification information from the storage device, in the case where interruption time of the interaction processing exceeds the valid duration.

12. The interactive system according to any one of claims 1 to 11, in which the interaction control device can cause the terminal newly connected to the interactive system to select whether the terminal starts the new interaction processing or the terminal participates in the already ongoing interaction processing.

13. The interactive system according to any one of claims 1 to 11, in which the interaction control device uses the intrinsic information as the identification information to the terminal, and
the interaction control device obtains the intrinsic information from the terminal newly connected to the interactive system, and the interaction control device automatically causes the terminal to participate in the interaction processing concerned with the identification information in the case where the intrinsic information coincides with the identification information stored in the storage device.

14. An interaction control method which is executed by a computer system including a communication device performing communication with at least one terminal and a storage device, comprising steps of:
generating identification information for identifying interaction processing to store the identification information in the storage device, and transmitting the identification information to each terminal, when the new interaction processing with the terminal is started;
executing a series of interaction processings in response to information received from the terminal;
causing the terminal or another terminal different from the terminal to participate in the interaction processing concerned with the identification information, in the case where the same identification information as the identification information of the ongoing interaction processing is received from the terminal or another terminal different from the terminal when the interaction processing is in progress.

15. An interaction control method which is executed by a computer system including a communication device performing communication with a terminal and a storage device, comprising steps of:
transmitting identification information for identifying the interaction processing to the terminal while storing the identification information in the storage device, when the new interaction processing with the terminal is started;
executing a series of interaction processings in response to information received from the terminal;
storing the identification information in the storage device while progress information for indicating a degree of progress is corresponded to the identification information, when the interaction processing is in progress; and
permitting the terminal or another terminal different from the terminal to participate in the interaction processing from the degree of progress in which interruption has occurred, when the same identification information as the identification information of the interrupted interaction processing is received from the terminal or another terminal different from the terminal after the interaction processing is interrupted.

16. The interaction control method according to claim 15, further comprising a step of permitting the terminal or another terminal different from the terminal to participate in the interaction processing concerned with the identification information, in the case where the same identification information as the identification information of the ongoing interaction processing is received from the terminal or another terminal different from the terminal when the interaction processing is in progress.

17. An interaction control program which can be executed by a computer system including a communication device performing communication with at least one terminal and a storage device, the interactive control program causing the computer system to sequentially execute steps of:
transmitting identification information for identifying interaction processing to the terminal while storing the identification information in the storage device, when the new interaction processing with the terminal is started;
executing a series of interaction processings in response to information received from the terminal;
permitting the terminal or another terminal different from the terminal to participate in the interaction processing concerned with the identification information, in the case where the same identification information as the identification information of the ongoing interaction processing is received from the terminal or another terminal different from the terminal when the interaction processing is in progress.

18. An interaction control program which can be executed by a computer system including a communication device performing communication with at least one terminal and a storage device, the interactive control program causing the computer system to sequentially execute steps of:
transmitting identification information for identifying interaction processing to the terminal while storing the identification information in the storage device, when the new interaction processing with the terminal is started;
executing a series of interaction processings in response to information received from the terminal;
storing the identification information in the storage device while progress information for indicating a degree of progress is corresponded to the identification information, when the interaction processing is in progress; and
permitting the terminal or another terminal different from the terminal to participate in the interaction processing from the degree of progress in which interruption has occurred, when the same identification information as the identification information of the interrupted interaction processing is received from the terminal or another terminal different from the terminal after the interaction processing is interrupted.

19. The interaction control program which can be executed by a computer according to claim 18, further comprising a step of permitting the terminal or another terminal different from the terminal to participate in the interaction processing concerned with the identification information, in the case where the same identification information as the identification information of the ongoing interaction processing is received from the terminal or another terminal different from the terminal when the interaction processing is in progress.

20. An interactive system comprising:
a communication device which performs communication with a terminal;
a interaction control device which responds to information received from the terminal to execute a series of interaction processings; and
a storage device,
wherein the interaction control device stores identification information for identifying the interaction processing when the new interaction processing is started, and the interaction control device can cause the terminal to participate in the interaction processing concerned with the identification information in the case where the interaction control device receives the same identification information as the identification information of the ongoing interaction processing from the same terminal or another terminal when the interaction processing is in progress.
